(19) United States
(12) Patent Application Publication
(10) Pub. No.: US 2008/0040976 A1
(43) Pub. Date: Feb. 21, 2008

(54) SECURITY WINDOW OR SECURITY DOOR WITH BURGLAR-RETARDANT FEATURES

(75) Inventor: Heinrich Salzer, Marburg (DE)

Correspondence Address: Ursula B. Day;Henry M. Feiereisen, LLC, Suite 4714, 350 Fifth Avenue, New York, NY, 10118, US

(73) Assignee: Salzer Sicherheitstechnik GmbH, Marburg (DE)

(21) Appl. No.: 11/830,381

(22) Filed: Jul. 30, 2007

(30) Foreign Application Priority Data
Aug. 15, 2006 (EP) 06016974

(51) Int. Cl. E06B 5/11

(52) U.S. Cl. 49/50; 52/204.1

(57) ABSTRACT

A security window of door has a frame anchorable in an opening of a building and a casement, which is provided with a filling and is mounted in the frame for tilting around at least one tilt axis and whose tilt movement is delimited in a tilt final position by at least one security scissor hinge connecting the casement to the frame and attached on the side of the casement diametrically opposite the tilt axis, wherein the security against break-in attempts is increased even in the tilted state of the casement when at least one locking element connected fixed to the frame engages using an engagement area in a formfitting way in a depression in the casement at least in the tilt final position in such a way that a movement of the casement parallel to the tilt axis in relation to the frame is suppressed in at least one direction.

### CROSS-REFERENCES TO RELATED APPLICATIONS

This application claims the priority of European Patent Application Serial No. 06 016 974, filed Aug. 15, 2006, pursuant to 35 U.S.C. 119(a)-(d), the subject matter of which is incorporated herein by reference.

### BACKGROUND OF THE INVENTION

The present invention relates to a security window or a security door in a burglar-retardant embodiment, having a frame anchorable in an opening of a building and a casement, provided with a filling and mounted so it is tiltable in the frame at least around a tilt axis, whose tilt movement is delimited in a tilt final position by at least one security scissor hinge which connects the casement to the frame and is preferably attached on the side of the casement diametrically opposite the tilt axis.

Up to this point, the relevant standards of burglar-retardance in windows or doors have always related to the closed state of the casement, which is mounted in the frame so it is rotatable and/or tiltable. In the closed state, locking elements situated on the casement, which are typically displaced using a pushrod, which is in turn actuated using a one-hand rotating handle, into matching designed locking elements, which are situated fixed on the frame. Comparatively good security to attempts at breaking in or breaking open is achieved by an appropriately large number of locking elements, i.e., a configuration thereof at short distances to one another on all four casement legs (typically two vertical and two horizontal) as much as possible, in connection with a strongly pronounced form fit between the locking elements, which, for example, are implemented in the form of male and female molds and engage with one another in a formfitting way.

DE 92 11 974 U1 and DE 94 09 388 U1 are cited here as examples of windows whose properties retarding explosive effect are improved in the closed state.

However, the burglar retardance in the tilted state of the casement is inadequate in security windows of this type. In this state, the locking elements are not active, because they are not engaged with one another due to the corresponding position of the pushrods, but rather are displaced in relation to one another by displacement of the pushrod and are disengaged. In burglar-retardant security windows as well, in this case, the connection of the casement to the frame in the area of the tilt axis is typically formed solely by standard tilt-turn bands in the area of the vertical rotational axis of a tilt-turn window and/or a bearing socket on the diametrically opposite side of the casement, a bearing element actuated using the pushrod engaging in the bearing socket in the tilted position. Fitting parts of this type, as they are also used in standard windows which do not have to meet security requirements, do not withstand stronger and more sustained attacks on the security window in the tilted position.

However, it is increasingly viewed as inadequate in this context if a security window only has sufficient security properties in the closed position. Rather, it is also desirable to be able to leave a security window fixed in the tilted position for reasons of adequate ventilation, without the burglar-retardant effect being entirely and/or largely lost in this way. In addition, the problem arises that it is undesirable and/or frequently very difficult to always check whether all windows are located in the closed position of the casement, which is the only satisfactory position from security aspects.

A window implemented to retard explosive effect is known from EP-A-1 516 996, which is to have its properties retarding explosive effect in particular also in the tilt final position. For this purpose, the known window is provided on the side of the casement diametrically opposite the tilt axis with a security scissor hinge made of stainless steel, which is anchored on one side fixed in the frame profile and on the other side engages, in the area of the end of the scissor hinge which may be coupled to and displaced using the pushrod, in a bearing element, which engages using a retention part in a profiled chamber of the casement, by which tearing out of the security scissor hinge is prevented even under great tensile load.

This window implemented to retard explosive effect is not satisfactory in regard to burglar retardance, because locking elements engage with one another in a formfitting way in the area of the tilt axis on the casement and frame sides and prevent the sash from being pressed in the area of the tilt axis. Because the lower end of the casement profile also engages below the locking elements mounted fixed on the frame, lifting of the sash and/or the casement under the effect of a pressure wave or also in the event of a break-in attempt is suppressed. However, the security in relation to displacement of the casement in the horizontal direction parallel to the tilt axis is unsatisfactory, because neither the casement profile engaging around the locking elements on the frame nor the formfitting interlocking of the locking elements on the frame and casement may oppose this movement with a resistance.

It would therefore be desirable and advantageous to provide an improved security window or door to obviate prior art shortcomings and to provide a security window or door which provides security against displacement of the casement in the horizontal direction parallel to the tilt axis even in the tilted position of the casement.

### SUMMARY OF THE INVENTION

According to one aspect of the present invention, a security window or a security door in a burglar-retardant embodiment, at least one locking element connected fixed to the frame, which engages at least in the tilt final position using an engagement area in a formfitting way in a depression in the casement in such a way that a movement of the casement parallel to the tilt axis in relation to the frame is suppressed in at least one direction.

The formfitting engagement according to the present invention of the engagement area of a locking element fixed on the frame in a depression in the casement prevents a horizontal displacement of the casement in relation to the frame in at least one direction and thus significantly increases the security from break-in and/or breaking open in relation to the known security window. The security window or the security door according to the present invention thus allows the casement to be left continuously in the tilt final position if desired, without significantly thus reducing the security properties in relation to the closed position of the sash. Sufficient protection against break-in or breaking open is not provided in the tilt final position in the windows and/or doors from the prior art. It is especially advantageous in the achievement of the object according to the present invention that the locking elements which cause the fixing of the casement are situated fixed on the frame, i.e., do not have to be actuated using the pushrod. In spite of the formfitting engagement in a depression in the casement, while maintaining this formfitting engagement, it is possible both to transfer the casement into the closed position and also to transfer the casement into an open rotating position, if the window is a tilt-turn window, engagement no longer being provided in the open position, of course.

If at least two locking elements connected fixed to the frame are provided, at least one of which suppresses the movement of the casement in a direction parallel to the tilt axis and at least one other of which suppresses the movement of the casement in the opposite direction parallel to the tilt axis, the security is increased further, because as a result movement of the casement is no longer possible in the horizontal direction parallel to the tilt axis.

As an alternative to two locking elements fixed on the frame which only act on one side, it is also possible that at least one locking element connected fixed to the frame suppresses a movement of the casement in both opposing directions parallel to the tilt axis and thus exerts a double function efficiently.

Advantageously, at least one locking element is situated on the leg of the frame assigned to the tilt axis, even if it is possible in principle to also situate a locking element on one of the perpendicularly running legs of the frame in proximity to the leg of the frame assigned to the tilt axis, because the distance between the casement and the frame is still very small in this area even in the tilt final position.

In a further embodiment of the present invention, it is suggested that the security window or the security door have a tilt-turn function and the locking elements allow a rotational movement of the casement around a rotational axis running perpendicular to the tilt axis. At the comparatively slight required engagement depth, the rotational movement of the casement around the vertical rotational axis requires a hardly detectable lateral widening of the depression in the casement, to also avoid a collision between the engagement area of the connecting element fixed on the frame and the edge of the depression on the casement side during the rotational movement.

If already existing casement profiles of burglar-retardant security windows are used, it is especially simple to produce the depression in the casement by milling out an area therein and/or introducing an inlay into a chamber thereof. The milled-out area may be tailored very exactly to the geometry of the engagement area of the locking element on the frame.

An especially intimate connection between the frame and the casement is achieved in its tilt final position if the locking element is a bracket projecting from the inner visible side of the frame and preferably screwed thereon, which engages in a groove in the edge area of the casement deepened by milling. The bracket may extend over almost the entire length of the lower horizontal casement leg if needed and its front faces form a buttress face for the front faces of the groove in the casement, whose length is tailored to the bracket. An already partially provided groove for introduction on a lower lip seal on the casement may be used as the basis for this groove. A groove of this type, as is already frequently present in windows according to the prior art, does not have an adequate depth, however, to cause secure engagement in the tilted position of the casement. For this reason, deepening this groove to approximately double its original depth by milling is advisable.

To particularly prevent the possibility of lever tools penetrating into the lower gap between casement, profile, and frame, it is suggested that the bracket engaging in the groove be a leg of a U-profile and the other leg cover the lower edge of the casement and thus prevent the placement of lever tools there.

Furthermore, it is also provided according to the present invention that the locking element may be engaged in the tilted position with a locking element which is attached to the casement and displaceable using a pushrod. In this way, not only is security provided against a horizontal displacement of the casement running parallel to the tilt axis, but rather also in a horizontal direction running perpendicular thereto.

In order that the security window or the security door according to the present invention also meets increased aesthetic and/or architectonic demands, it is provided that the locking element is situated so it is invisible from the interior of a room of the building having the opening in the closed position and in the tilt final position of the casement.

Finally, an advantageous refinement of the present invention also comprises the locking element connected fixed to the frame also preventing a vertical movement of the casement in its tilt final position, preferably upward and downward. Therefore, with a corresponding embodiment of the window according to the present invention, very effective fixing of the casement in relation to movement in nearly all spatial directions may be achieved

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a cross-section through a casement and frame profile in the area of the tilt axis of a first embodiment of a security window having an L-shaped bracket as the locking element;

FIG. 2 is similar to FIG. 1, but having a U-shaped bracket as the locking element;

FIG. 3a: is a further embodiment of a window in cross-section in its closed position;

FIG. 3b: is similar to FIG. 3a, but in the tilt final position;

FIG. 4a: is similar to FIG. 3a, but having an inlay in a cavity of the casement profile;

FIG. 4b: is similar to FIG. 4a, but in a tilt final position;

FIG. 5: is a further embodiment of a window in its closed position;

FIG. 6: is similar to FIG. 5, but in the open position;

FIG. 7: is a view of the locking elements of the window shown in FIGS. 5 and 6 on the casement and the frame.

### DETAILED DESCRIPTION OF PREFERRED EMBODIMENTS

Throughout all the Figures, same or corresponding elements are generally indicated by same reference numerals.

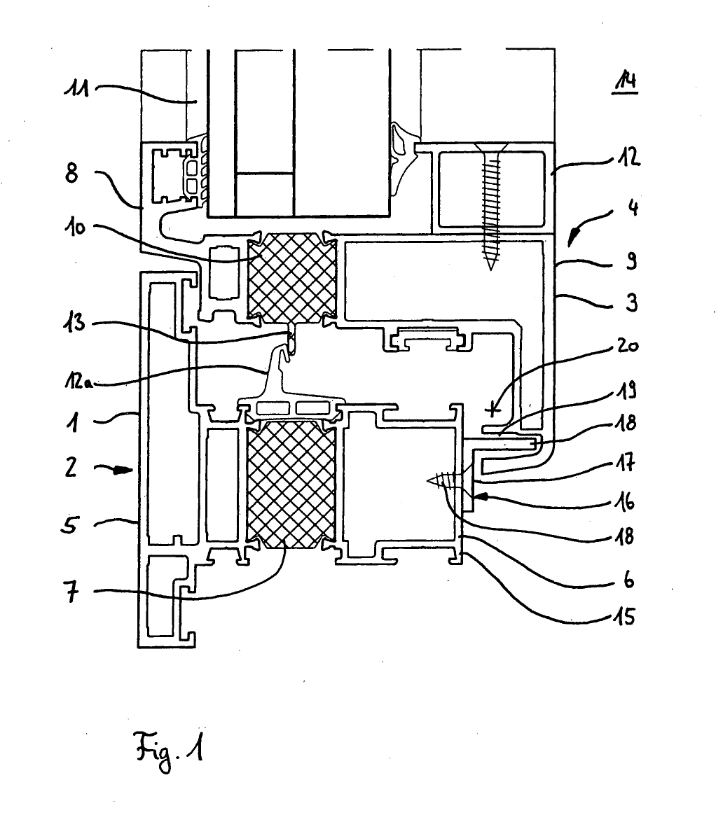

Turning now to the drawing, and in particular to FIG. 1, there is shown a security window in a burglar-retardant embodiment, which is only shown in detail in cross-section in FIG. 1, has a lower leg 1 of a frame 2 and a lower leg 3, corresponding thereto, of a casement 4, which is mounted in the frame 2 so it is tiltable around a horizontal tilt axis and rotatable around a vertical rotational axis. The profile of the leg 1 of the frame has an external frame profile 5 and an internal frame profile 6, which are both implemented as aluminum extruded profiles and are connected to one another in a thermally insulated way via an insulating web 7. Similarly, the leg 3 of the casement 2 comprises an external casement profile 8 and an internal casement profile 9, which is in turn connected via an insulating web 10 to the external casement profile 8. A burglar-retardant filling 11, comprising a multipane composite insulating glass, is introduced into the casement 4, which is fixed therein using a glass retention bracket 12 situated on the interior of the window and screwed to the internal casement profile 8.

A middle seal 12a comprising rubber-elastic material, which is situated on the lip 13 of the insulating web 10 of the casement 4, is located in the area of the mortise for the purpose of sealing the gap between the casement 4 and the frame 2.

A locking element 16 in the form of an L-shaped bracket is attached by screwing to the internal frame profile 6 on its visible side 15 assigned to the interior of the room 14. The L-shaped bracket 16 has a fastening leg 17, on which it is screwed to the frame profile 6 using screws 18. The bracket 16 also has an engagement area 18 in the form of the leg running perpendicular to the fastening leg 17. This leg engages in a matching groove 19, which is provided in the internal casement profile 9. This groove 19 results by milling, i.e., by deepening a groove originally provided for a rubber lip seal, which would be used without the milling deepening for receiving a corresponding seal profile, but would not have the groove depth required for an effective form fit.

FIG. 1 shows the window in a closed position of the casement 4. The engagement of the engagement area 18 of the bracket 16 shown in FIG. 1 is not only provided in the closed position of the casement 4 shown, but rather also in its tilt final position, which is not shown in the drawing, but in which the casement 4 is tilted inward by approximately 10°. This changes almost nothing of the engagement conditions between the engagement area 18 of the bracket 16 in the groove 19, because the window is pressed against the internal frame profile 6 in this lower edge area of the internal casement profile 9.

The length of the engagement area 18 of the bracket 16 corresponds to the length of the groove 19, so that front sides of the engagement area 18 of the bracket 16 may work together as buttress faces with front-side walls of the groove 19 and thus suppress a displacement of the casement 4 in a horizontal direction parallel to the tilt axis 20.

A security scissor hinge, which delimits the tilt movement of the casement 4 in the frame 2 in a so-called tilt final position, is located on the diametrically opposite side of the window between the frame 2 and the casement 4. Such a security scissor hinge is described, for example, in EP-A-1 516 996. The window according to the present invention is thus protected in the area of the security scissor hinge both against displacement to the right and left and also against pressing in and/or pushing into the room.

In the lower area of the window, the bracket 16 has the effect that the casement may not be forcefully lifted upward. Furthermore, however, the bracket 16 prevents the casement 4 from being able to be displaced in the horizontal direction parallel to the tilt axis 20 and relative to the frame 2 according to the present invention. Overall, high security against break-in is thus achieved.

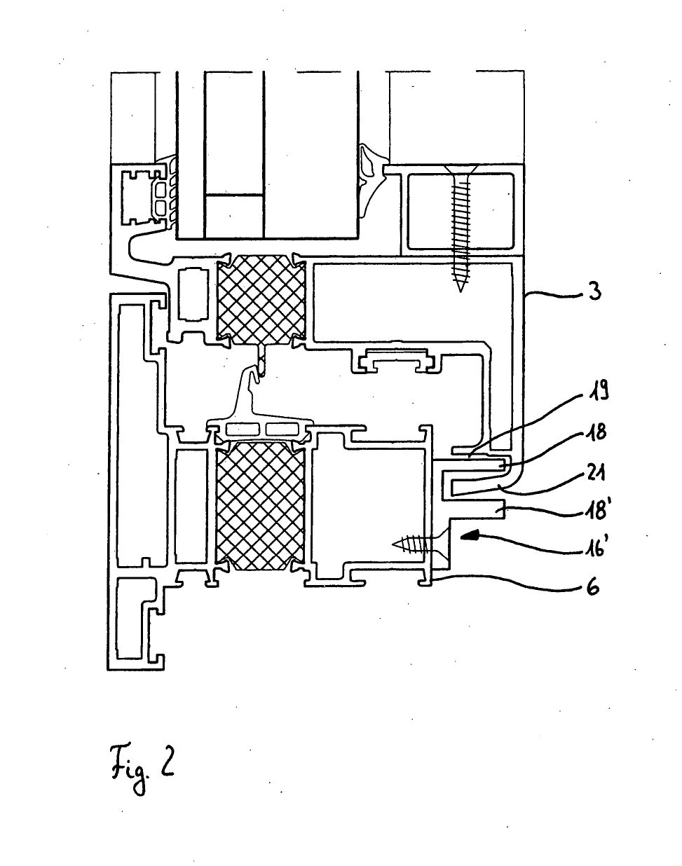

The window according to FIG. 2 differs from the window shown in FIG. 1 solely due to the deviating shape of the bracket 16′ attached to the internal frame profile 6. This is U-shaped in cross-section in the upper area. In addition to the bracket 16, as is also shown in FIG. 1, the bracket 16′ shown in FIG. 2 has a leg 18′, which runs below the lower edge 21 of the internal casement profile 6 and thus covers this edge area 21, i.e., protects it against penetration of a lever tool diagonally from below. Moreover, the mode of operation of the upper bracket, which functions as an engagement area 18 in the groove 19 of the casement profile 6 and prevents a lateral horizontal displacement parallel to the tilt axis, is identical to the window according to FIG. 1.

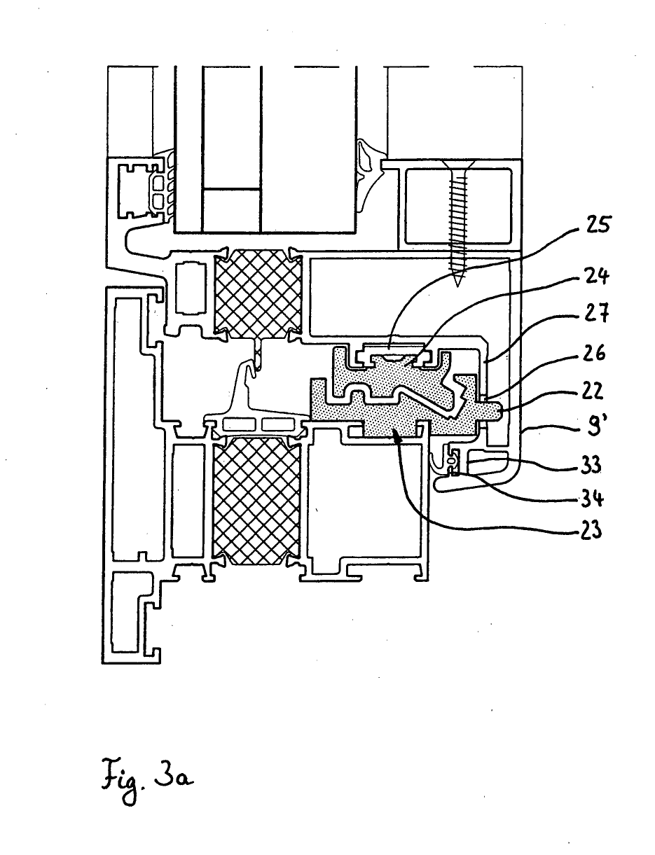

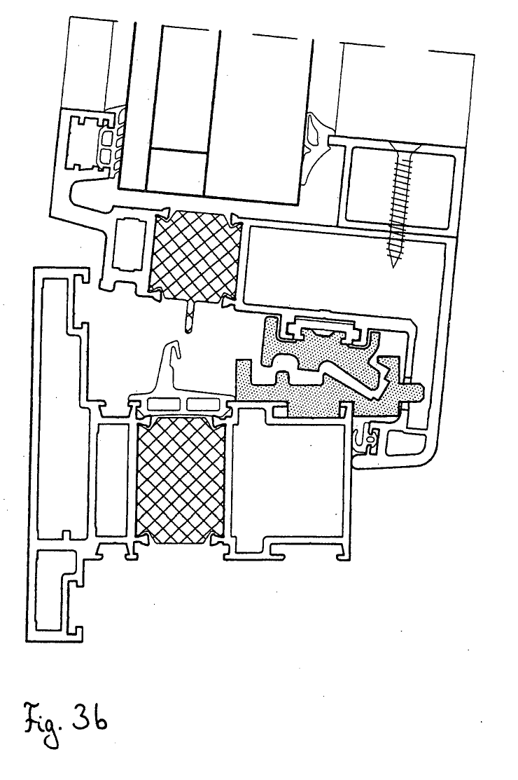

In the window shown in FIGS. 3a (closed position) and 3b (tilted position), the engagement area 22 therein is formed by a lug on the locking element 23 fixed on the frame which projects perpendicularly to the plane of the filling of the window. The locking element 23 on the frame is engaged in a formfitting way with a matching locking element 24 connected to the casement 4′ like a female mold/male mold. This engagement exists both in the closed position of the window shown in FIG. 3a and also in the tilted position shown in FIG. 3b, but not in a rotating position, because of which in this position the two locking elements 23 and 24 are disengaged by lateral displacement of the locking element 24 using the pushrod 25, so that the window may be rotated into an open position around a vertical rotational axis.

While the locking elements 23 and 24 may not prevent a horizontal movement of casement and frame to one another in a direction parallel to the tilt axis 20, because they are displaceable in relation to one another in this direction due to the possibility of rotating the sash, this displacement security is caused according to the present invention by the engagement of the locking element 23 in the internal casement profile 9′. A formfitting engagement exists both in the closed state and also in the tilted state of the casement 4′ between the lug-shaped engagement area 22 and a matching recess 26 in an internal wall 27 in the internal casement profile 9′. The milled-out area 26, whose length parallel to the tilt axis is tailored to length of the engagement area 22 (with little play), thus forms the depression according to the present invention in the casement 4′ for producing the displacement security in the direction of the tilt axis 20.

To further increase the security and strength in the area of the formfitting connection between the engagement area 21 and the internal casement profile 3′, an inlay 29 tailored to the width of this intermediate space, which may be manufactured from stainless steel or aluminum, for example, is located between the wall 27 of the internal casement profile 9′ and the external wall 28. The inlay 29 has approximately the same height as the intermediate space, i.e., it abuts the wall 30 on the bottom with little play and the wall 31 of the casement profile 9′ on top with little play. The inlay 29 is inserted into the lower horizontal leg 3 before the casement 4′ is assembled from four legs and may preferably extend over the entire length of this casement leg 3.

The opening 26 in the wall 27 of the internal casement profile 9′ and the opening 32 in the inlay 29 correspond in their height and width and are tailored—having the required play—to the dimensions of the engagement area 22 of the locking element 23.

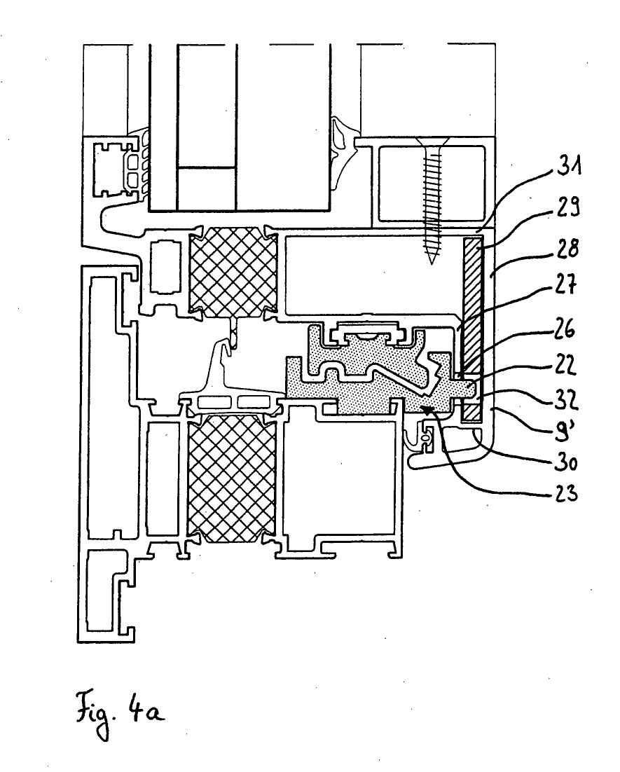

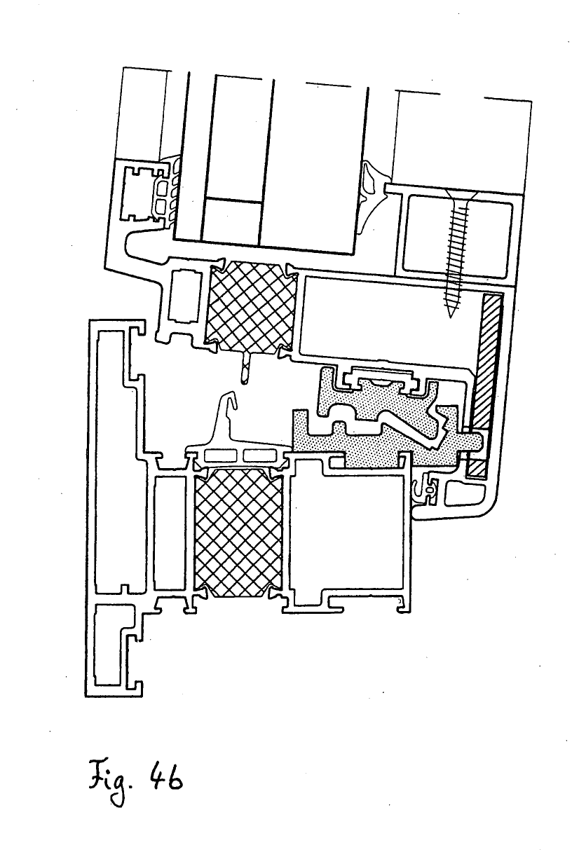

The internal casement profile 9′ shown in FIGS. 3a, 3b and 4a, 4b is also used as a starting product for the production of the casement profile 9 from FIGS. 1 and 2. The groove 19 shown therein has been depressed and/or expanded by removal of the web 33 shown in FIGS. 3a, 3b and 4a, 4b and the two diametrically opposite small ribs 34, to obtain a sufficient engagement depth between the legs of the bracket 16, 16′ forming the engagement area 18 and the groove.

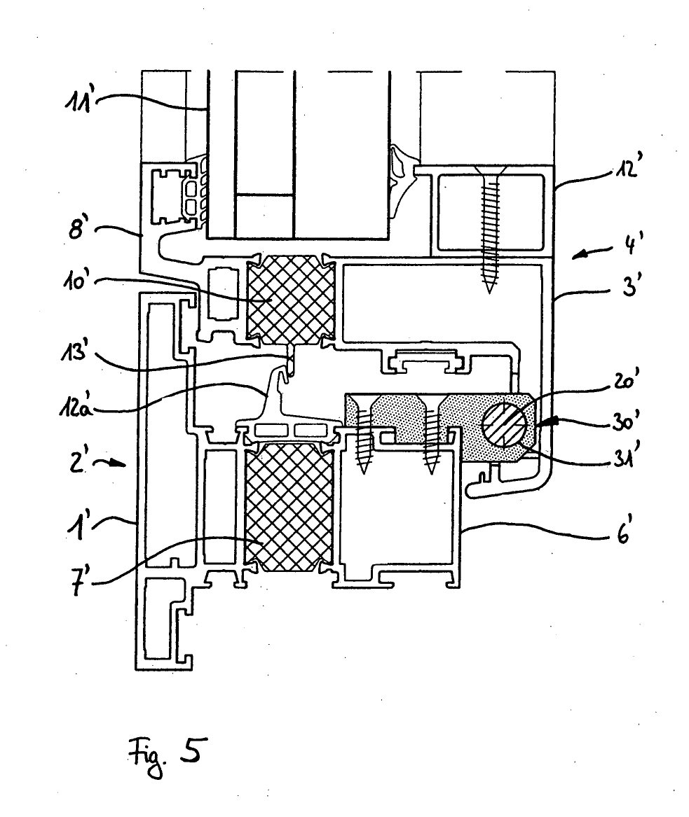

A security window is described with reference to FIGS. 5 through 7 which comprises a frame 2′ anchored fixed in an opening of a building and a casement 4′, provided with a filling 11′ made of an insulating security glass, which is mounted in the frame 2′ so it is tiltable around a horizontal tilt axis 20′ and is rotatable around a vertical rotational axis (not shown). On the side diametrically opposite the tilt axis, the casement 4′ is connected using a security scissor hinge (not visible) to the frame 2′, the security scissor hinge preventing further deflection in a tilt final position, in which the casement 4′ is pivoted inward by a tilt angle of approximately 10° in relation to the frame 2′, the security scissor hinge being under tension in this case.

The frame 2′ comprises an external frame profile 1′, which is coupled via an insulating web 7′ to the internal frame profile 6′. In the same way, the casement 4′ comprises an external casement profile 8′ and an internal casement profile 3′ coupled thereto via an insulating web 10′. The filling 11′ is held in the casement 4′ using a glass retention bracket 12′. A lip seal 12a′ situated between the internal frame profile 6′ and the external frame profile 1′ corresponds to a web 13′ which is situated on the insulating web 10′ of the casement 4′.

A locking element 30′ shown in FIG. 5, which is connected fixed to the internal frame profile 6′ on the frame side, has a cylindrical pin 31′, which runs perpendicularly to the plane of the drawing of FIG. 5 and is milled on the free front side, and which projects out of the main body 32′ of the locking element 30′.

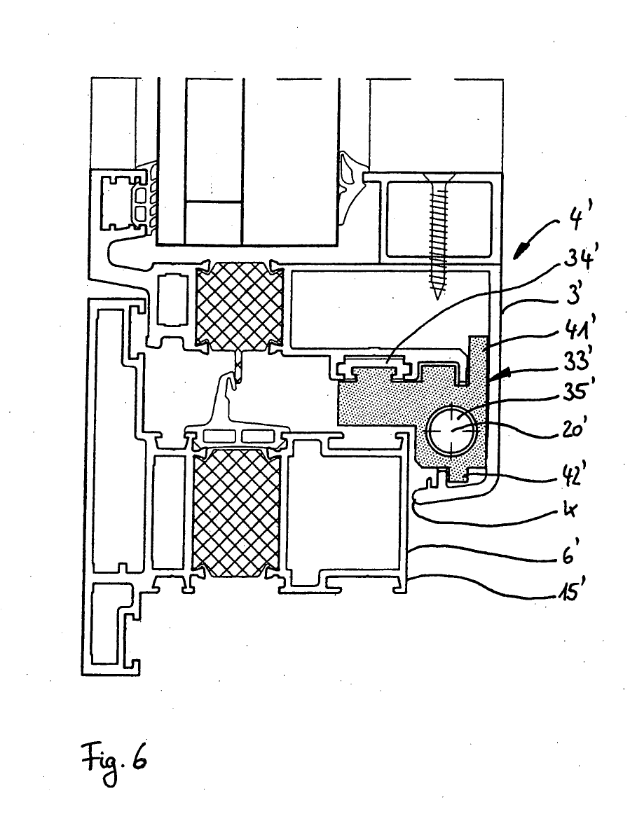

In contrast, FIG. 6 shows a first locking element 33′ situated on the casement side, which is coupled to a pushrod 34′ and is displaceable corresponding to the movement of the pushrod 34′ in relation to the casement 4′ within its internal casement profile 3′ in a direction parallel to the tilt axis 20′. The first locking element 33′ has a bearing hole 35′ milled on the front side, whose diameter is tailored to the diameter of the pin 31′ of the second locking element 30′ on the frame 2′. The engagement conditions are shown in FIG. 3′. In this position of the locking elements 30′ and 33′ to one another, the casement 4′ of the window is transferable from the closed position shown in FIGS. 5 and 6 into the tilted position (not shown in the drawing), a pivot movement occurring around the tilt axis 20′. The lower inner edge “k” of the internal casement profile 3′ thus precisely abuts the visible side 15′ of the internal frame profile 6′.

Both in FIG. 5 and also in FIG. 6, both locking elements 30′ and 33′ would be visible depending on the selected sectional plane. However, for the sake of clarity, only the second locking element 30′ shown in FIG. 5 and only the first locking element 33′ is shown in FIG. 2′, while in contrast both are shown in FIG. 3′.

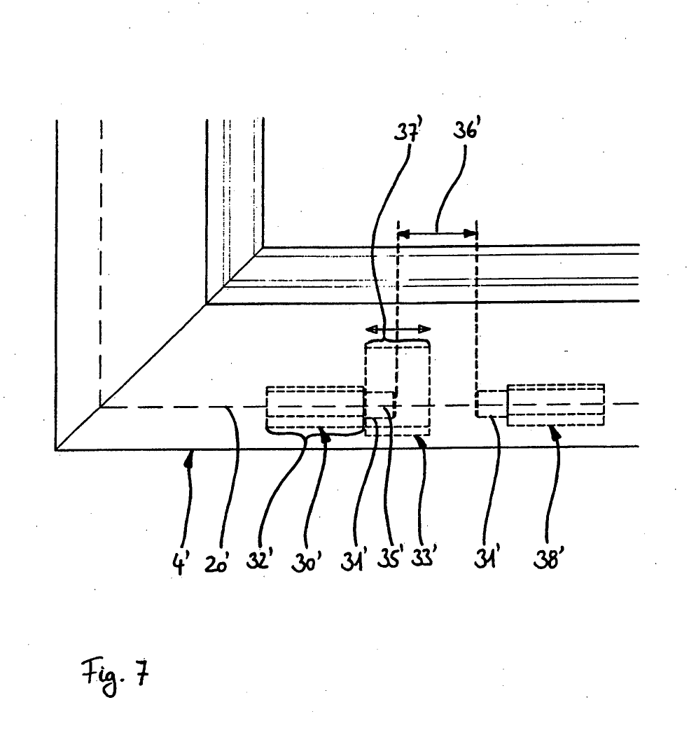

Furthermore, it is obvious from FIG. 7 that a third locking element 37′ mounted fixed on the frame side is provided at a distance 36′ between the pin 31′ and is situated in a mirror image to the second locking element 30′, i.e., the two pins 31′ point toward one another. The width 37″ of the first locking element 33′, which is coupled to the pushrod and displaceable in the horizontal direction parallel to the tilt axis 20′, is slightly less than the distance 36′ between the locking elements 30′ and 37′, so that in the rotating position of the pushrod 34′, in which the first locking element 33′ is located precisely between the two locking elements 30′ and 37′, there is no engagement, so that the casement 4′ may be rotated around a vertical rotational axis together with the first locking element 33′.

The third locking element 37′ on the frame side is used to increase the security in the closed position of the pushrod 34′, with which the first locking element 33′, which is provided with a through bearing hole, may also be engaged in a formfitting way like an auxiliary pivot joint. This position is not shown for reasons of clarity in FIG. 7, however.

While the invention has been illustrated and described as embodied in security window or door, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A security window or door, comprising:
a frame constructed for anchoring in an opening of a building;
a casement received in the frame and tiltable about at least one tilt axis into a final tilting position;
at least one locking element securely connected to the frame and provided with an engagement area for formfittingly engaging a depression in the casement, when the casement is tilted to the final tilting position, and thereby preventing a movement of the casement in at least one direction relative to the frame in parallel relationship to the tilt axis.

2. The security window or door of claim 1, wherein at least one security scissor hinge is connecting the frame and the casement and limiting a tilting movement of the casement, and wherein the scissor hinge is arranged on a side of the casement in opposition to the tilt axis.

3. The security window or door of claim 1, wherein the casement includes a filling.

4. The security window or door according to claim 1, wherein there are at least two locking elements securely connected fixed to the frame, wherein at least one of the two locking elements prevents a movement of the casement in a direction parallel to the tilt axis and another one of the two locking elements prevents a movement of the casement in the opposite direction parallel to the tilt axis.

5. The security window or door according to claim 2, wherein at least one of the at least two locking elements prevents a movement of the casement in both opposing directions parallel to the tilt axis.

6. The security window or door according to claim 1, wherein the at least one locking element is situated on a leg of the frame assigned to the tilt axis.

7. The security window or door according to claim 1, wherein the window or door has a tilt-turn function and through the at least one locking element a rotational movement of the casement around a rotational axis extending perpendicularly to the tilt axis is realized.

8. The security window or door according to claim 1, wherein the depression in the casement is a milled-out area.

9. The security window or door according to claim 1, wherein the at least one locking element is a bracket projecting from an internal visible face of the frame for engagement in a milled groove in an edge area of the casement.

10. The security window or door according to claim 7, wherein the bracket includes a U-profile with two legs and a third leg abutting the lower edge of the casement.

11. The security window or door according to claim 2, further comprising a second locking element attached to the casement and movable by means of a pushrod and wherein the first locking element engages with the second locking element in the tilted position when the second locking element is moved.

12. The security window or door according to claim 1, wherein the at least one locking element is situated so it is invisible from an interior of a room where the window or door is located when the casement is in a tilted position or in a closed position.

13. The security window or door according to claim 1, wherein the at least one locking element is securely connected to the frame prevents a vertical movement of the casement when in its tilt final position in both upward and downward direction.

14. The security window or door according to claim 1, comprising a second locking element coupled to the casement and wherein the casement is mounted so it is rotatable around a vertical rotational axis, and wherein the second locking element is coupled to a pushrod of the casement and the pushrod is guided concealed in a mortise area between the casement and the frame for formfitting engagement with the second locking element when the pushrod is in a tilted position such that both locking elements are pivotable in relation to one another around the tilt axis, and disengaged from the first locking element in a rotating position of the pushrod in order realize a rotational movement of the casement around the rotational axis is possible.

15. The security window or door according to claim 1, further comprising an inlay in a chamber of the casement and wherein the depression in the casement is from material of the inlay in the horizontal direction on both sides and also in the vertical direction on both sides.
